(19) United States
(12) Patent Application Publication
(10) Pub. No.: US 2009/0307946 A1
(43) Pub. Date: Dec. 17, 2009

(54) Instruction Apparatus and Instruction Methods

(76) Inventors: Camille M. Cashatt, Liberty Lake, WA (US); Warren H. Toews, Liberty Lake, WA (US)

Correspondence Address: WELLS ST. JOHN P.S., 601 W. FIRST AVENUE, SUITE 1300, SPOKANE, WA, 99201, US

(21) Appl. No.: 12/137,049

(22) Filed: Jun. 11, 2008

(51) Int. Cl. G09F 1/00; G09B 29/00

(52) U.S. Cl. 40/124.04; 40/124.01; 434/430

(57) ABSTRACT

Educational tools are provided that can include a plurality of sets of placards with individual ones of these sets can include a plurality of individual placards, and individual placards within the sets having substantially the same surface area and can be associated with a common symbol. The educational tool can also include at least two of the sets including placards having different surface areas associated with different symbols. Educational methods are also provided that include providing a first set of placards, with the first set of placards including individual placards having a first surface area associated with a first symbol, and providing a second set of placards, with the second set of placards including individual placards having a second surface area associated with a second symbol.

### TECHNICAL FIELD

The present disclosure relates to instruction apparatus and instruction methods.

### BACKGROUND

There is a constant ongoing need for improved methods of communicating skills to students. Educators have struggled for centuries with the best way to teach students in the area of multiple parameter implementations. One example that has proven difficult over the years is the ability to instruct students with regard to a symbol that has a certain space variable such as time. One example is the use of time with respect to certain musical notes or symbols. The present disclosure provides teaching apparatus and methods that can overcome the shortcomings of the prior art teaching apparatus and methods.

### SUMMARY OF THE DISCLOSURE

Educational tools are provided that can include a plurality of sets of placards. Individual ones of these sets can include a plurality of individual placards. Individual placards within the sets can have substantially the same surface area and can be associated with a common symbol. The educational tool can also include at least two of the sets including placards having different surface areas associated with different symbols.

Educational methods are also provided that include providing a first set of placards, with the first set of placards including individual placards having a first surface area associated with a first symbol. The method can also include providing a second set of placards, with the second set of placards including individual placards having a second surface area associated with a second symbol. The method provides that the surface area and the symbols of the first set of placards are different from the surface area and the symbols of the second set of placards. The method can also include arranging the individual ones of the sets of placards on a board to occupy a surface area of the board, with the board being associated with the area occupied by the placards.

### DRAWINGS

Embodiments of the disclosure are described below with reference to the following accompanying drawings.

FIG. 1 depicts individual placards according to an embodiment.

FIG. 2 represents the surface area of individual placards in relation to one another according to an embodiment.

FIG. 3 represents individual placards on a surface area of a board according to an embodiment.

FIGS. 4 and 5 represent a package of sets of placards according to an embodiment.

FIG. 6 represents individual placards on a board according to an embodiment.

FIGS. 7A-D represent individual placards associated with individual symbols according to an embodiment.

### DESCRIPTION

This disclosure is submitted in furtherance of the constitutional purposes of the U.S. Patent Laws “to promote the progress of science and useful arts” (Article 1, Section 8).

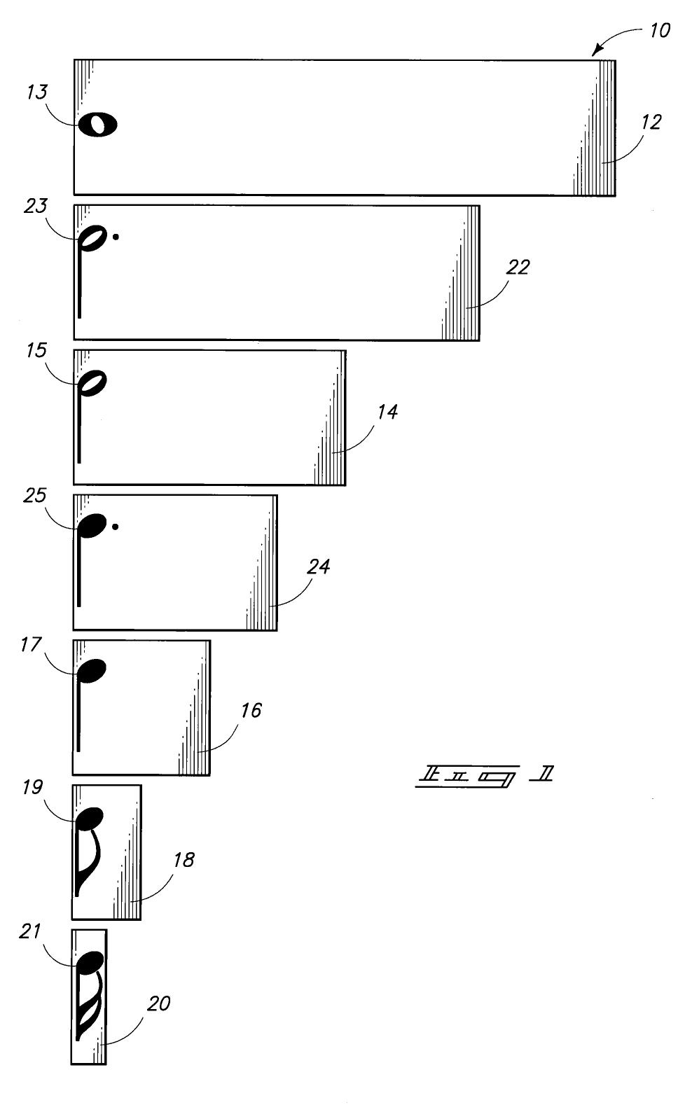

Embodiments of the disclosure will be described with reference to FIGS. 1-7. Referring first to FIG. 1, individual placards 10 are shown. These individual placards can be a part of an educational tool that includes a plurality of sets of placards. Individual ones of the sets of placards can comprise these individual placards, for example. As one example, placard 12 can have a surface area defined by its length and width and can be associated with a symbol 13, such as the whole note. The tool can comprise multiple placards substantially the same as that of placard 12 completing a set of a plurality of individual placards having substantially the same surface area associated with the same common symbol. The tool can also comprise additional placards of different surface areas being associated with different symbols.

For example, placard 22 can include a symbol 23 such as dotted half note. As another example, placard 14 can be provided being associated with a symbol 15 such as a half note. This placard 14 can have a surface area equal to half of the surface area of the placard 12 associated with a whole note 13. The tool can also include placard 24 having a symbol 25 associated therewith, such as a dotted quarter note. The tool can also comprise a placard 16 associated with a symbol 17 such as a quarter note. As depicted, placard 16 can represent a surface area that is approximately a quarter the size of placard 12 and half the surface area of placard 14. Placard 18 can also be provided that has a surface area that is approximately one eighth of placard 12, or a quarter of placard 14, or half of placard 16. Placard 18 can be associated with a symbol such as an eighth note 19. Further, placard 20 can be provided within the tool that has a surface area that is substantially one sixteenth of placard 12, or an eighth of placard 14, or a quarter of placard 16, or half of placard 18. Placard 20 can be associated with a symbol such as sixteenth note 21.

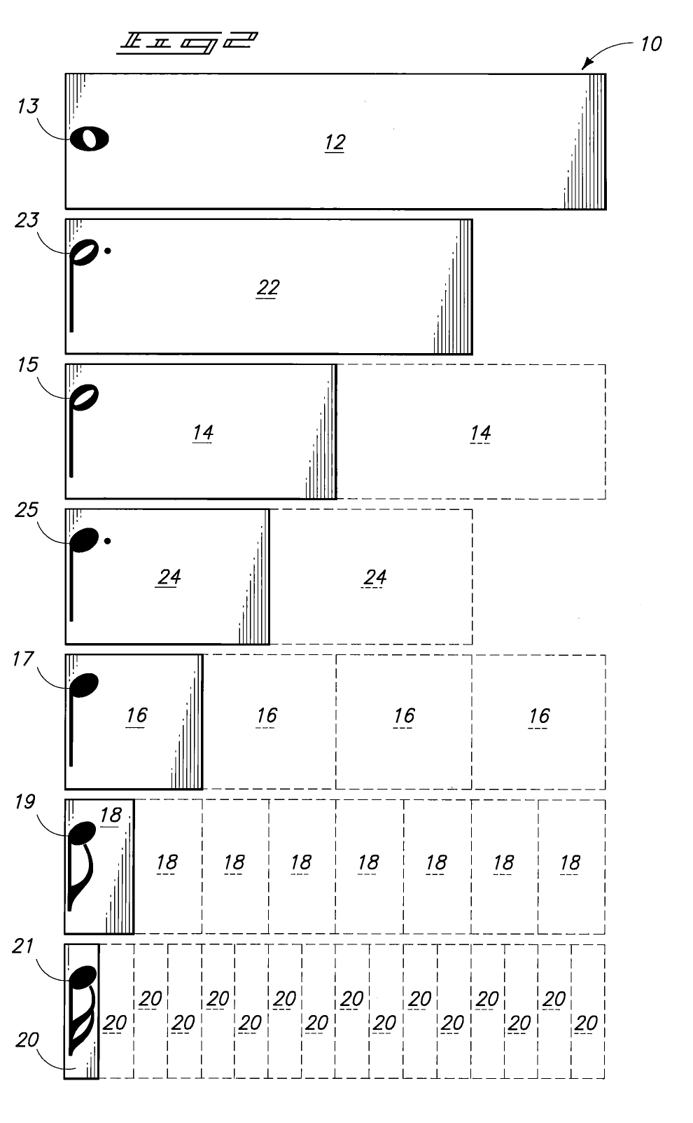

Referring to FIG. 2, to further demonstrate the relationship of the surface areas between the different placards 12, 22, 14, 24, 16, 18, and 20, respective varied dimensions are shown in outlined format. As can be seen, if two placard 14's are provided, they can occupy equal surface area to that of placard 12. With respect to placard 16, if four are provided, they can occupy the same surface area as placard 12. If two are provided they can occupy the same surface area as placard 14, and so on.

As shown with respect to FIGS. 1 and 2, individual placards within a set can be proportional to a time count of the musical symbol associated with the individual placard. Individual sets of these placards can comprise a first set and a second set, with the first set comprising a first placard associated with a whole note, for example, and the second set comprising a second placard associated with a half note, wherein the second placard has half the surface area of the first placard. The symbols are not limited to those of musical notes; the symbols can also include notes and/or rests, for example. The sets of placards can be associated with each note and rest. As depicted in FIGS. 1 and 2, the notes can comprise one or more of whole notes, dotted half notes, half notes, dotted quarter notes, quarter notes, eighth notes, sixteenth notes, whole rests, half rests, quarter rests, eighth rests, and sixteenth rests, for example.

These placards can be constructed of a flexibly resilient material. Example material can include that manufactured by Magnum Magnetics (Magnum Magnetics Corporation 801 Masonic Park Road Marietta, Ohio 45750, USA). The placards can also have two faces; one face displaying the symbol and the other face configured to be removably affixed to a board. This other face can be magnetic, for example, and the board can be configured to adhere to this magnetic material. Other materials can also be provided such as Velcro® or removably affixed adhesives.

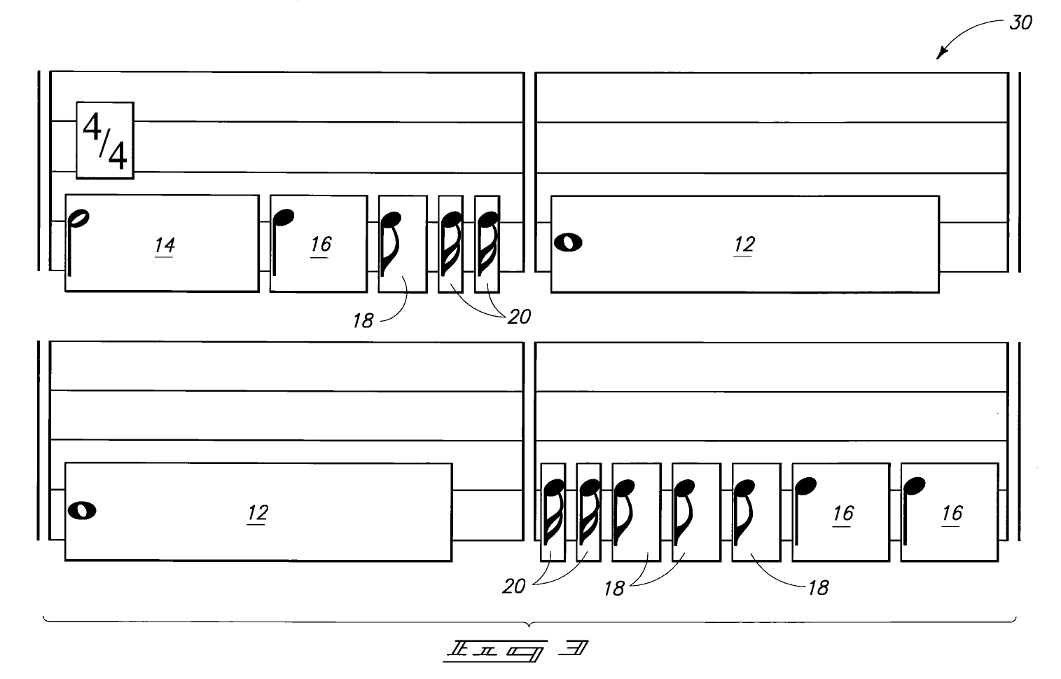

Referring to FIG. 3, an example board can display a measure of a musical line, for example. Placards as referred to above can be organized along the musical line to represent a time space occupation. For example, on a four count measure, a half note 14 can be arranged in combination with a quarter note 16; an eighth note 18, as well as two sixteenth notes 20. In the next measure of line 30, a complete whole note 12 can occupy the complete measure, and in the next measure, another complete whole note 12 can occupy the complete measure. Referring to the fourth measure, two sixteenth notes, two eighth notes, and two quarter notes can be utilized to occupy the complete measure.

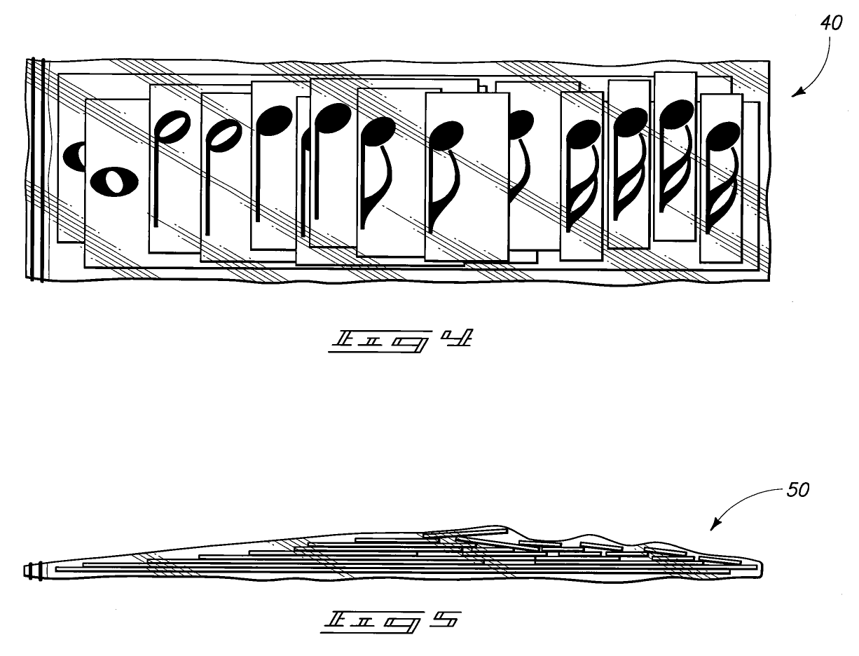

Referring to FIGS. 4 and 5, these sets of placards can be provided in a package for wholesale or retail use. Multiple sets of placards wherein the sets include a plurality of individual placards having the same surface area and related to the same symbol can be provided.

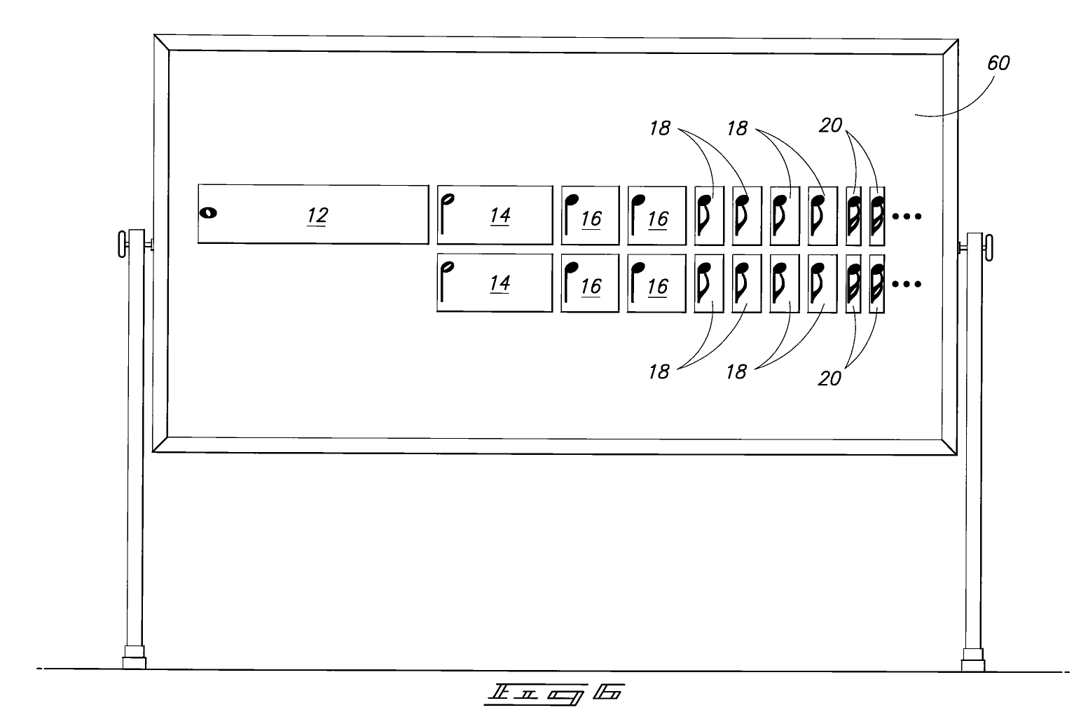

Referring to FIG. 6, an educational method can be performed that can include providing a first set of placards, the first set of placards comprising individual placards having a first surface area associated with a first symbol. Individual placards, for example, can include placard 14 attached to a board 16 such as, for example, the plurality of placards can include a magnetic backing that can adhere to an equally magnetic adhering board 60. A second set of placards can be provided with the second set of placards comprising individual placards having a second surface area associated with a second symbol. Example placards can include those that are associated with alternative notes, for example, half notes, quarter notes, eighth notes, and sixteenth notes. Individual ones of the sets of placards can be arranged on a board to occupy a surface area of the board with the symbols being associated with the area occupied by the placard. One example area of the board to be associated with the placards can be, for example, a measure within a musical line. The board itself can define at least one field having a field surface area, and this field surface area can be, for example, a measure associated with a musical line. According to an example embodiment, the field surface area can be wholly divisible by the first and second surface areas of the placards, for example. Examples of wholly divisible can include a whole note being divisible by the surface area of a measure wherein one whole surface area is divided by one whole note surface area, and the dividing number equaling one. Another example can be the division of a whole field surface area of the measure being divided by two half note placards wherein the dividing again equals one.

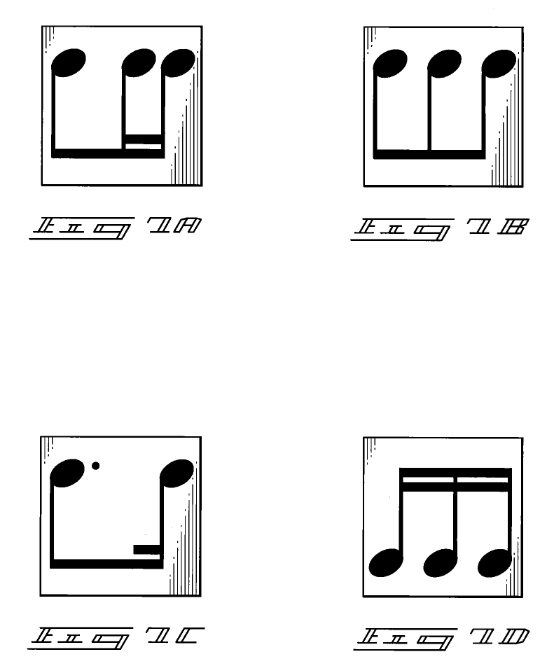

Referring to FIGS. 7A-D, in alternative embodiments, combinations of notes can be provided such as quarter notes and eighth notes in combination, and these notes can be associated with placards having surface areas commensurate with their time value.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1-16. (canceled)

17. A music education method comprising:
providing a first set of rectangular placards, the first set of placards comprising individual placards having a first rectangular surface area associated with first musical symbol, the placards being constructed of a flexibly resilient plastic material and having magnetic backing;
providing a second set of rectangular placards, the second set of placards comprising individual placards having a second rectangular surface area associated with a second musical symbol, wherein the surface area and the symbols of the first set of placards are different from the surface area and the symbols of the second set of placards; and
providing a substantially vertical magnetic board, the board depicting a musical staff, bar lines, and measure, wherein the measure defines an area of the board; and
arranging the individual ones of the sets of placards on the board along the musical staff to occupy a surface area of the board, the symbols being associated with the area defined by the measure.

18. The method of claim 17 wherein the musical symbols are bass clef notes.

19. The method of claim 18 wherein the first musical symbol is a sixteenth note and the second musical symbol is a whole note.

20. The method of claim 19 wherein the arranging comprises aligning the first placard lateral of the second placard.

21. The method of claim 20 further comprising removing the sets of placards from packaging prior to the arranging.
